(19) United States
(12) Patent Application Publication
(10) Pub. No.: US 2016/0246270 A1
(43) Pub. Date: Aug. 25, 2016

(54) METHOD OF CONTROLLING A DATA CENTER ARCHITECTURE EQUIPMENT

(71) Applicant: EATON INDUSTRIES (FRANCE) S.A.S., Montbonnot St Martin (FR)

(72) Inventors: Dominique Louis LALLEMENT, Grenoble (FR); Aurelien Louis BEGOU, Meylan (FR); Emilien Benoit KIA, Pontcharra (FR)

(21) Appl. No.: 15/031,307

(22) PCT Filed: Oct. 24, 2014
(86) PCT No.: PCT/EP2014/072803

§ 371 Date: Apr. 22, 2016

(30) Foreign Application Priority Data
Oct. 24, 2013 (GB) 1318778.6

(51) Int. Cl. G05B 17/02

(52) U.S. Cl. CPC G05B 17/02

(57) ABSTRACT

A method of controlling a data center architecture and data center having a plurality of devices of different types, involves executing a plurality of software applications executed on resources provided by the devices, wherein a computer device, which is temporarily or permanently connected to the data center is adapted to execute an application for controlling the data center architecture.

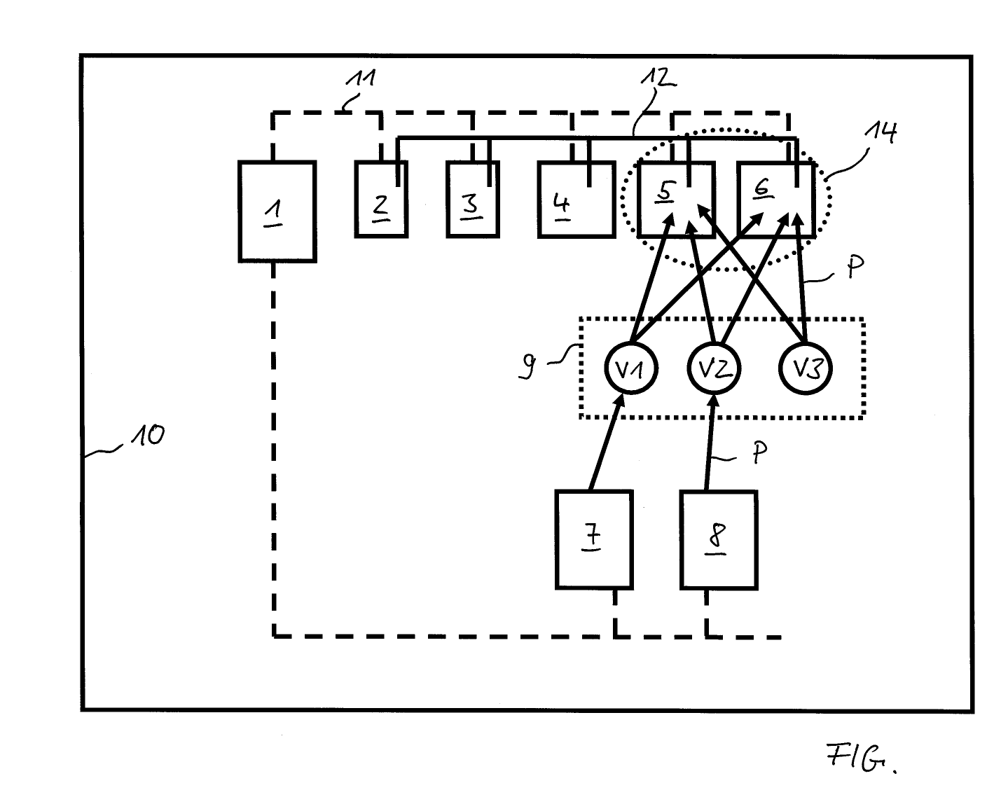

### CROSS-REFERENCE TO RELATED APPLICATIONS

This application is a U.S. national stage application under 35 U.S.C. §371 of International Application No. PCT/EP2014/072803, filed on Oct. 24, 2014, and claims benefit to British Patent Application No. 1 318 778.6, filed on Oct. 24, 2013. The International Application was published in English on Apr. 30, 2015, as WO 2015/059256 A1 under PCT Article 21(2).

### FIELD

The present invention relates to a method of controlling a data center architecture and to a data center comprising a plurality of devices of different types, a plurality of software applications being executed on resources provided by the devices, wherein a computer device, which is temporarily or permanently connected to the data center is adapted to execute an application for controlling the data center architecture.

### BACKGROUND

Data centers are widely used to house various types of electrical equipment devices, including computer systems and the physical infrastructure needed to support such systems, such as power supplies, including uninterruptible power supplies and backup power supplies, environmental systems, like air conditioning, fire suppression, etc., physical data center security, and other monitoring devices. Companies that depend on the proper and efficient operation of their data centers use various tools to monitor and operate the physical infrastructure, including multiple monitoring systems that are coordinated to provide centralized collection and reporting of critical infrastructure events. A method and apparatus for data center automation is disclosed in WO 2011/031459 A2.

With the large number of mutually connected information technology equipment devices, a problem arises if any action like implementing an individual setting or reconfiguration or individually controlling on an application or on a device is executed, as it is difficult to anticipate the consequences on other related applications or application parts or equipment devices. Even more difficult to anticipate are the consequences on other related applications or application parts or equipment devices, if any action like a global setting or a set of settings or a set of reconfigurations or control commands is executed on an application or on a device. A lack of awareness about dependencies between different parts or devices in a data center does not permit to define the proper set of related devices and related applications in order to optimize a command sequence. User defined static or manually defined scripts or sequences are error-prone, because there is no automatic discovery of dynamic changes in the data center architecture.

### SUMMARY

An aspect of the invention provides a method of controlling a data center architecture, the data center including a plurality of devices of different types, a plurality of software applications being executed on resources provided by the devices, the method comprising: acquiring information on links between the devices, between the software applications, and/or between the devices and the software applications; processing the information acquired in the acquiring to generate and/or update a model of the data center architecture so as to establish relations between the devices, between the software applications, and/or between the devices and software applications; and implementing command sequences for controlling the devices and/or software applications, the command sequences being set up based on of the data center architecture model generated and/or updated in the processing.

### BRIEF DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

The FIGURE schematically illustrates an embodiment of a data center according to the present invention.

### DETAILED DESCRIPTION

An aspect of the present invention provides a data center architecture control that is capable of automatically discovering dynamic changes in the data center architecture.

An aspect of the invention provides a method of controlling a data center architecture, wherein a computer device, which is temporarily or permanently connected to the data center, is adapted to execute an application for controlling the data center architecture according to the method according to the invention.

The method of controlling a data center architecture according to the invention is applied in a data center comprising a plurality of devices of different types, in particular information technology equipment, like servers, network devices and also electrical and mechanicals equipment, like UPS, PDU, cabinets with related environment devices, like thermal conditioning devices. The devices are connected by one or more networks. A plurality of software applications is executed on resources provided by the devices, in particular by the servers. The method comprises the steps of
a) acquiring information on links between the devices, between the software applications and/or between the devices and the software applications;
b) processing the information acquired in step a) to generate and/or update a model of the data center architecture, wherein relations between devices, between software applications and/or between devices and software applications are established; and
c) implementing command sequences for controlling the devices and/or software applications, the sequences being set up on the basis of the data center model generated in step b).

Links in the sense of the invention are any kind of information about an attribution of a device to another device, or of a device to an application, or of an application to another application, independent from a quality of the attribution. The generated model reflects the acquired information on the links, supplemented, if applicable, by additional information about the link, in the sense of an information on a quality of the respective link, which is expressed by the expression relation, which is used after the acquired information on a link has been processed in step b).

It is an advantage of the present invention that the relations between the different devices and applications are automatically discovered and updated. It is avoided to set the same information many times, as the existing information is reused by applying the model for executing any actions on the data center. The information available from the devices and software applications is advantageously acquired automatically, which information provides, in general, an identification of each device and application, but also information on the links between devices and/or applications. Any sequence of commands to execute an action on the data center may advantageously be implemented considering the model with the relations, which allows to exactly anticipate the consequences incurred on related devices and/or applications of the data center.

According to a preferred embodiment, a plurality of different protocols is applied to acquire the information on links according to step a). In particular, the plurality of different protocols includes protocols related to different abstraction layers, with respect to an OSI model. Advantageously, links will be discovered on any layer of communication perused in the data center, from a hardware layer to an application layer.

According to a further preferred embodiment, acquiring the links according to step a) implies an identification of the devices on a basis of characteristic data related to each device. The identification of a device, in particular the detection of a type of device, provides important information for the analysis of the links of the device in order to provide a qualified statement on the relation of the device to other devices and/or applications.

The plurality of devices will generally include at least one network device, like a router etc. and acquiring the links according to step a) thus preferably implies acquiring network routing information from each of the present network devices, which, for example are stored as routing tables containing information on a plurality of links established via the respective network device.

Where the plurality of software applications includes a power management tool, acquiring the links according to step a) preferably implies acquiring manually defined or automatically discovered power links between the devices, which are handled by the power management tool.

Where the plurality of software applications includes an infrastructure management application, acquiring the links according to step a) preferably implies acquiring information about locations of the devices, power cable connections and/or network cable connections managed by the infrastructure application.

According to a furthermore preferred embodiment, the data center architecture model generated according to step b) includes a virtualized architecture of the data center, wherein the devices include a plurality of physical servers, wherein each server comprises one or more server resources allocable to one or more virtual machines on each server and wherein each virtual machine handles operations for a different one of the plurality of software applications.

The plurality of software applications will generally include at least one virtualization management application to control a resource allocation of the one or more resources to the one or more virtual machines running on each server and wherein acquiring the links according to step a) preferably implies acquiring a list of the virtual machines with the related resources.

Furthermore preferred, acquiring the links according to step a) implies acquiring a definition and/or composition of at least one set of resources being logically linked to a cluster by the virtualization management application.

According to a furthermore preferred embodiment, the relations between devices, between software applications and/or between devices and software applications established in step b) are distinguished into compulsory relations and redundant relations. The relations reflected by the model may on the one hand imply that a set of devices are necessary to accomplish and support one application, which may be expressed as logical “AND” relations. The relations may on the other hand imply that parts of the devices are redundant and that a subset of such devices is sufficient to accomplish and support one particular application, which may be expressed by logical “OR” relations. Examples of an “OR” relation may, for example, be found in server clusters and in parallel configuration of UPS devices.

Preferably, the steps a), b) and c) of the method according to the invention are repeated regularly, in particular, to initially generate the model of the data center and to subsequently update the model.

Subject to the present information is further a data center comprising a plurality of devices of different types, a plurality of software applications being executed on resources provided by the devices, wherein a computer device temporarily or permanently connected to the data center is adapted to execute an application for controlling the data center architecture using a method according to the invention as described here above.

The invention is now further described with respect to an example of an application of the method according to the invention. The description refers both to the method and the data center according to the application. It is only exemplary and does not limit the scope of the invention.

The only FIGURE schematically illustrates an embodiment of a data center according to the present invention.

With regard to the FIGURE, the steps of the method according to the invention will be illustrated with respect to a data center 10. The data center 10 comprises exemplary devices 1-8 and exemplary network connections 11, 12, a software application 9 being executed on a plurality of virtual machines V1, V2, V3, the virtual machines using resources of the devices 5, 6 and receiving information from devices 7, 8, which is illustrated by arrows, of which only two are denoted with the reference P.

The first step of the method according to the invention (step a) is, to acquire information about the links between the devices, between the software applications and/or between the devices and the software applications, preferably through different communication protocols. A power equipment device 1 is powering the devices 2-8 via a power connection 11, depicted as a broken line. A network device 3 is connected to devices 2, 4, 5, 6 by a network communication connection 12, which will usually use a different communication protocol than the power connection 11, for example. Using different communication protocols is thus advantageous to detect and acquire as many links of the data center 10 as possible.

The device 2, for example, could be a computer device 2, which is temporarily or permanently connected to the data center 10, where the method of the invention is executed in the form of a software application. The second step (step b) of the method is, to process the information acquired in step a) to generate and/or update a model of the architecture of the data center 10, wherein relations between devices, between software applications and/or between devices and software applications are established, i.e. to compute the information about the links in order to create and update the model and to manage the model. The functionality of step b) is to recognize the relations between the devices and application by logically analyzing the acquired links. The relations of the exemplary data center 10 are, for example:
the power equipment device 1 is powering devices 2, 3, 4, 5 and 6;
the network equipment device 3 provides a network link 12 to devices 4, 5, and 6, which have been identified as servers;
the application 9 is composed of virtual machines V1, V2, V3 running in servers 5 and 6;
the virtual machines V1 and V2 are using devices 7 and 8, which have been identified as data servers 7, 8; and
the servers 5,6 are part of a common server cluster 14.

The model is constituted on the basis of such relations. A part of the relations imply that a set of devices are necessary to accomplish and support one application in the sense of a compulsory relation or a logical “AND” relation. Another part of the relations also imply that some parts of the set of devices are redundant and that a subset of such devices is sufficient to accomplish and support one particular application in the sense of logical “OR” relations. An example of a redundant relation can be found in the server cluster 14 in the exemplary data center 10 or in parallel configuration of UPS devices (uninterruptible power supply, not depicted).

The third step of the method according to the invention (step c) is, to use the model in order to realize appropriate sequences, i.e. to implement command sequences for controlling the devices 1-8 and/or software applications 9, the sequences being set up on the basis of the data center model generated in step b). There are many ways to advantageously use the relations of the model. For example, if it is desired to execute a complete shutdown sequence, a shutdown command sequence will be defined, based on the relations. Referring to the exemplary data center 10 and the relations described above, for example, as the following sequence will be executed:
shutdown virtual machines V1 and V2;
shutdown data servers 7 8, unless they are used by other virtual machines;
shutdown servers 5 and 6, unless they are used by other virtual machines;
shutdown network device 3, unless it provides network to other devices than 7, 8, 5 and 6; and
shutdown power device 1, unless it provides power to other equipment than 7, 8, 5 and 6

The three steps a), b) and c) of the method according to the invention are preferably executed regularly in order to update the relations of the model and the command sequences. The method of the invention will advantageously support data center operators or automatic management systems to determine the appropriate set of settings and the appropriate sequence of control commands that permit safe and coherent behavior of the applications and devices.

As an example of setting, the operator or automatic setting system may need to determine how much time of power backup provided by UPS is necessary for each server or for other IT devices, according to their relations with a certain application.

As an example of control commands, the operator or automatic protection system needs to define the proper command sequence to stop or restart certain applications and devices.

As an example of reconfiguration, the operator or automatic power management system needs to reconfigure the distribution of parts of the application, i.e. a set or subset of virtual machines, through different servers in order to optimize an energy consumption or a reliability of the application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE NUMERALS

1 Power supply device

2 Computer device

3 Network device

4-6 Server

7, 8 Data server

9 Software application

10 Data center

11 Power supply line

12 Communication network

14 Cluster

V1, V2, V3 Virtual machines

P Arrow

1. A method of controlling a data center architecture, the data center including a plurality of devices of different types, a plurality of software applications being executed on resources provided by the devices, the method comprising:
acquiring information on links between the devices, between the software applications, and/or between the devices and the software applications;
processing the information acquired in the acquiring to generate and/or update a model of the data center architecture so as to establish relations between the devices, between the software applications, and/or between the devices and software applications; and
implementing command sequences for controlling the devices and/or software applications, the command sequences being set up based on of the data center architecture model generated and/or updated in the processing.

2. The method of claim 1, wherein the acquiring includes applying a plurality of different protocols to acquire the information on the links.

3. The method of claim 2, wherein the plurality of different protocols includes protocols related to different abstraction layers.

4. The method of claim 1, wherein the acquiring of the links includes an identification of the devices based on characteristic data related to each device.

5. The method of claim 1, wherein the plurality of devices includes at least one a network device, and
wherein the acquiring of the links includes acquiring network routing information from each network device.

6. The method of claim 1, wherein the plurality software applications includes a power management tool, and
wherein the acquiring of the links includes acquiring manually defined or automatically discovered power links between the devices.

7. The method of claim 1, wherein the plurality of software applications includes an infrastructure management application, and
wherein the acquiring of the links includes acquiring information about locations of the devices, power cable connections, and/or network cable connections.

8. The method of claim 1, wherein the data center architecture model generated and/or updated during the processing includes a virtualized architecture of the data center,
wherein the devices include a plurality of physical servers,
wherein each server includes a server resource allocable to one or more virtual machines on each server,
wherein each virtual machine handles operations for a different one of the plurality of software applications.

9. The method of claim 8, wherein the plurality of software applications includes a virtualization management application to control a resource allocation of the one or more resources to the one or more virtual machines running on each server, and
wherein the acquiring of the links includes acquiring a list of the virtual machines with related resources.

10. The method of claim 9, wherein the acquiring of the links includes acquiring a definition and/or composition of at least one set of resources being logically linked to a cluster by the virtualization management application.

11. The method of claim 1, wherein the relations between devices, between software applications, and/or between devices and software applications established during the processing are distinguished into compulsory relations and redundant relations.

12. The method of claim 1, wherein the acquiring, the processing, and the implementing are repeated regularly.

13. A data center, comprising:
a plurality of devices of different types; and
a plurality of software applications being executed on resources provided by the devices
wherein a computer device temporarily or permanently connected to the data center operates to execute an application for controlling the data center architecture using the method of claim 1.
